(19) United States
(12) Patent Application Publication
(10) Pub. No.: US 2010/0191611 A1
(43) Pub. Date: Jul. 29, 2010

(54) PORTABLE ELECTRONIC CONSTRUCTION ESTIMATOR

(76) Inventor: Janos Biro, San Clemente, CA (US)

Correspondence Address: DONALD W. MEEKER, 924 EAST OCEAN FRONT, # E, NEWPORT BEACH, CA, 92661, US

(21) Appl. No.: 12/360,789

(22) Filed: Jan. 27, 2009

(51) Int. Cl. G06Q 30/00; G01C 21/00; G06Q 50/00

(52) U.S. Cl. 705/26; 701/213

(57) ABSTRACT

An electronic estimator has a clipboard size electronic touch screen. The contractor can draw on it, use it as a touch screen to select materials for a job, estimate costs including a running total of costs for a job, and input all client info. After initial contact by a potential customer, the contractor can input the client information including location and use a global positioning system (GPS) to travel to the client location. The contractor can use it to order materials for the job from the supplier.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to construction data management and particularly to an electronic construction estimator system which comprises a software program for a computer in the office and a handheld electronic estimator for use in the field; the handheld electronic estimator comprising a touch-screen, an electronic pen, a GPS system, a credit card reader, wireless phone capability, Internet connectivity, a memory for holding a client database, job estimation and material purchasing software, and software that allows displaying photographs, movies and flash movies to a client.

2. Description of Related Art Including Information Disclosed Under 37 CFR 1.97 and 1.98

Computer systems using job estimating software are well known in the field of construction. A contractor must be in the office to make use of said software. This is inconvenient for the consumer as they have to travel to the contractor's office.

Hand-held calculators are widely used in the building trade, for example in estimating the cost of materials such as lumber, pipes, conduits, ducts, wiring and cabling. They are likewise useful in calculating such things as the cost of real estate and the heating and air conditioning requirements of a building. The usefulness of such calculators for job cost estimations is somewhat restricted. For example in estimating the cost and material required, the architect or engineer must first obtain certain measurements, for example by measuring a scale drawing with a ruler and feed these measurements into the calculator. Examples of construction calculators may be found in U.S. Pat. Nos. 6,721,623; 5,997,475; 4,744,044; 4,488,250; 4,100,603; 4,081,859; and 3,973,113.

None of the prior art patents provide a convenient dedicated device for construction estimating including GPS locating of client and cost estimates.

U.S. Pat. No. 6,961,586, issued Nov. 1, 2005 to Barbosa, shows field assessments using handheld data management devices. Methods and systems for executing field assessments use handheld devices provide assessors portable access to industry-specific programs and data useful in carrying out a field assessment. Field assessment data synchronization and/or delivery is enabled using wireless capabilities resident in handheld personal computing devices. Data may be synchronized with a server over a network using wireless radio transmission, or directly to a computer workstation using wireless infrared or radio transmission or connected means (e.g., modems, cradles, docking stations). It is another aspect of the invention to provide for two-way communication between remote computing means (e.g., servers, desktop computers) and handheld data management devices to facilitate real-time access to remote programs, assistance and/or information related to the field assessment being undertaken by using a handheld data management device user.

U.S. Patent Application #20070095887, published May 3, 2007 by Barbosa, provides a method of conducting field operations using handheld data management devices, wherein users in the field have portable access to industry-specific programs, instructions and data. Field data synchronization and/or delivery is enabled using wireless capabilities resident in handheld personal computing devices. Data can be synchronized with a server over a network using wireless radio transmission, or directly to a computer workstation using wireless infrared or radio transmission or connected physical connection. Two-way communications is provided between remote computers and handheld data management devices to facilitate real-time access to remote programs, assistance and/or information related to the field assessment being undertaken by using a handheld data management device user. Field data management includes activities for at least one of: construction industry project analysis, HVAC system analysis, project management, equipment readiness inspection, troubleshooting, inventory tracking, inventory ordering, sales (e.g., providing cost estimates to customers), customer invoicing, conducting legal investigations, field data collection, and multi-user remote function coordination.

U.S. Pat. No. 6,915,216, issued Jul. 5, 2005 to Troxler, illustrates a measurement device incorporating a locating device, a portable handheld computer device and associated apparatus, system and method. The system is adapted to determine a property of a paving-related material. Such a system comprises a central computing system housing database, such as a geographic information system (GIS). A measuring device for selectively and directly measuring the property of the paving-related material is remotely disposed with respect to the central computing system and operably engaged with a locating device, such as a global positioning system (GPS) device, for determining a location of the measuring device when the property of the paving-related material is selectively measured thereby. A portable handheld computer device is in communication with the measuring device, the locating device, and the central computing system, wherein the handheld computer device is configured to receive data, comprising the measured property of the paving-related material and the corresponding location of the measuring device when the property is selectively measured thereby, from the measuring device and the locating device, and to communicate the data with the central computing system for incorporation of the data into the database. An associated device, apparatus, and method are also provided.

U.S. Patent Application #20040260504, published Dec. 23, 2004 by Bienvenu, describes a system for determining a property of a paving-related material comprising a paving-related measuring device incorporating a computer device and communication element therebetween and associated method. The measuring device selectively and directly measures the property. A computer device is capable of executing a software program product and communicating with the measuring device. The computer device directs the measuring device to measure the property of the paving-related material according to a parameter determined by the software program product, and to receive data comprising the measured property from the measuring device. A communication element operably engaged between the measuring device and the computer device allows communication therebetween. The communication element is configured to allow the computer device to be spaced apart from the measuring device, thereby allowing the computer device to be prepared, to include the parameter and to manipulate the data, in spaced apart relation with respect to the measuring device.

U.S. Pat. No. 7,283,975, issued Oct. 16, 2007 to Broughton, discloses a system and methods for assisting a contractor in managing information associated with a construction project. The amount of information relating to labor, materials, scheduling and billing and the number of individuals accessing the information can be overwhelmingly large for even a simple construction project. As such, the system and methods described are particularly useful for gathering, maintaining and disseminating the voluminous amount of information associated with a construction project. In one method, a drawing from a construction project is provided that has one or more intelligent objects. Information is then gathered relating to labor, materials and schedules for the project. The information is associated with the respective intelligent object and visually represented on the drawing. The drawing is displayed and certain aspects associated with the intelligent objects can be quickly identified. In addition, reports may be generated that quickly and efficiently organize information according to any number of user selected criteria. In some embodiments, emissive tags, such as RFID tags, associated with construction items are used in the data gathering process.

U.S. Pat. No. 7,313,759, issued Dec. 25, 2007 to Sinisi, relates to a system and method for mobile data collection in which a handheld device collects and integrates one or more forms of data. For example, data can include text, digital photographs, digital video, barcodes, sketches, digital signatures, audio, GPS, GIS, document scan, print scan, CAD/CAM scan, and interactive data retrieval from other systems data. Firmware on the handheld device provides a data collection template as a visual display on the handheld device to provide a user interface for collecting the forms of data. The data collection template can comprise consecutive questions nested in menus or submenus, data collection prompts and commands for guiding a user through data collection activities. A permanent record is generated from the collected data. The permanent record is synchronized to manipulate data in the record for later use such as optimization of the data collection template, production of reports from the collected data and storage of the collected data. The data collection template can be optimized during use of the handheld device to organize selections on the data collection template based on certain criteria, such as frequency of use or to reduce redundancy of text data entry and re-order menus or submenus to provide expedient data entry of the most frequently entered selections.

U.S. Patent Application #20020087449, published Jul. 4, 2002 by Como, discloses a system and method for a cost estimator for locally varying projects. The invention comprises a system and method for estimating costs of goods and services for at least one designated location by validating requested items against similar items valid for the designated location through using a gap analysis program and providing estimated costs of validated requested items.

U.S. Patent Application #20020103710, published Aug. 1, 2002 by Como, indicates a system and method for enabling a user to manage resources through an automated virtual jobsite office for goods and services purchased for at least one designated location.

U.S. Patent Application #20020026343, published Feb. 28, 2002 by Duenke, indicates a material and labor cost estimating method and system for estimating the construction costs related to mechanical contracting, electrical contracting, fire protection or processing businesses. The method and system utilizes databases of construction material items, graphical representations of the items, material and labor costs, and a data entry screen to estimate a construction project. Groups of items that comprise a typical system being installed may be defined to include all the related equipment and hook-ups to install the typical system. The group of items may also be graphically displayed to illustrate the connection of the equipment to a main construction line. The estimated construction costs may be calculated upon selection of construction items.

U.S. Patent Application #20060015475, published Jan. 19, 2006 by Birkner, puts forth an integrated construction project management system which includes a handheld computer adapted to collect construction data including an Inspection Checklist from the field; a planning system to track budgetary information; a design system to perform site engineering assessment; and a construction system to track material consumption and progress for each project, the construction system adapted to receive data collected from the handheld computer.

U.S. Patent Application #20070005412, published Jan. 4, 2007 by Martinez, concerns an electronic requirement management system with checklists on a handheld computer. The construction management system includes a handheld computer adapted to collect construction data from the field and to automatically provide a checklist; a planning system to track budgetary information; a design system to perform site engineering assessment; and a construction system to track material consumption and progress for each project, the construction system adapted to receive data collected from the handheld computer.

U.S. Patent Application #20080004844, published Jan. 3, 2008 by Kefford, provides a system for and method of estimating project costs. Geometric information is extracted from a design plan for the project and a cost estimate for the project is automatically generated using the geometric information extracted from the design plan and a computerized cost data store that contains cost estimates for the extracted geometric information. Either during the project, or after the project has been completed, actual cost data relating to the geometric information is electronically received and this actual cost data is used to update the computerized cost data store.

U.S. Patent Application #20060235611, published Oct. 19, 2006 by Deaton, shows systems and methods for recording and reporting data collected from a remote location. A work order, defining infrastructure to be inspected at a remote site and including an inspection plan for collecting inspection information, is generated on a first computer system and transferred to a portable computing system. Inspection data is collected pursuant to the inspection plan on the portable computing system. A global positioning system (GPS) receiver associated with the portable computing system provides location information related to inspected infrastructure during the inspection. After collection, inspection data is transferred from the portable computing system to the first and/or to a second computing system for storage and the generation of related reports. The location information obtained during the inspection can be used to determine dimensional measurements of the infrastructure and to generate visual depictions of infrastructure components and defects.

Two U.S. Patent Applications, #20060074609 and #20060074608 published Apr. 6, 2006 by Freeman, claim a system and method for determining variance in building structures and for designing and scheduling building construction. The system includes a three dimensional design system that generates three dimensional design data using one or more elements in a spatial tree structure. One or more recipes are associated with each element, where each recipe has one or more associated method components and each method component has one or more associated resource components. A cost estimate system generates cost estimate data using the recipes, and a schedule system generates schedule data using the recipes. An estimate system applies one or more variances to one or more of the recipes, methods or resources.

U.S. Patent Application #20020198755, published Dec. 26, 2002 by Birkner, puts forth an integrated quality assurance control system to manage construction projects. The construction management system includes a handheld computer adapted to collect construction data from the field; a planning system to track budgetary information; a design system to perform site engineering assessment; and a construction system to track material consumption and progress for each project, the construction system adapted to receive data collected from the handheld computer, store daily project reports and generate key indicator reports.

U.S. Patent Application #20030069716, published Apr. 10, 2003 by Martinez, concerns a system and method for performing field inspection. The field inspection system includes a handheld computer; a camera coupled to the computer to capture an image or video; a sketch pad coupled to the handheld computer to capture a sketch; and code to annotate the image and to communicate the image to a remote computer.

U.S. Patent Application #20050261930, published Nov. 24, 2005 by Litz, illustrates a method and system for detailed construction estimating. The method and system for construction estimating facilitates the estimation of construction activities, including at least one of metal stud framing, wallboard construction, ceiling suspension, acoustical ceiling tile construction and related insulation systems. The method includes the steps of: (a) compiling construction activity data in a database, (b) categorizing the data in the database according to construction related parameters, and (c) employing a database analysis and reporting system to construction estimating. The method and system provide a comprehensive and organized construction-estimating database for construction estimating professionals, construction service business owners, and for suppliers of general contractors, construction managers, construction developers and architects.

U.S. Patent Application #20050108982, published May 26, 2005 by Formisano, is for a dynamic residential construction cost estimation process. The residential construction estimation process includes the steps of: inputting conceptual level data, selecting design characteristics, calculating a virtual geometry, selecting assemblies of construction components based on the calculated virtual geometry, selecting component options based on the selected assemblies of construction components, identifying a cost of each of the selected component options, and calculating a cost of the residence, wherein the cost is dynamically linked to each of the selected and inputted information of the preceding steps, such that the cost of the residence can be dynamically modeled at a detailed component level.

U.S. Pat. No. 7,139,564, issued Nov. 21, 2006 to Hebert, claims a wireless communication device for field personnel. The system for provides direct field technical, troubleshooting, engineering analysis, equipment performance and efficiency analysis, new equipment and parts information, invoicing and sales support by means of data input and data retrieval in the field through the use by field located personnel of a hand-held, wireless communication device that allows direct field communication with a base or service provider master computer and software programs. The system also provides utilization of a base or service provider located mater computer and software programs to provide all the primary computing processes needed to support a limited field located data entry and retrieval device that could further use the input data to establish a master computer file for a customer, equipment, performance and invoicing database.

U.S. Pat. No. 6,826,539, issued Nov. 30, 2004 to Loveland, describes a virtual structure data repository and directory. The invention relates to a computer accessible system for electronically storing a model which communicates the physical attributes of a structure along with warranty, insurance, information regarding construction materials, and other information relative to that structure. The invention integrates physical information in a model which is displayed as a physical representation of the structure with other non-physical information. Selecting specific areas of the model provides access to data regarding physical or non-physical characteristics of that area of the structure and the contents thereof. Data relevant to warranties, insurance, maintenance or other information can be accessed by selecting portions of the model or indices attached or related to that portion. Equipment, appliances and other items within the structure may also be controlled by access through the computer model. Systems of the invention allow multiple users to remotely access the information and model via a computer network, such as the Internet, in order to make informed decisions regarding the structure and its characteristics.

U.S. Pat. No. 6,922,701, issued Jul. 26, 2005 to Ananian, indicates a method for generating an interactive profile of a structure, such as a building, employing an interactive profile system that preferably utilizes an Internet web browser to interface with a user. The interactive profile system includes an application engine embodied in a computer program that is preferably based within a server. A plan set, usually in a CAD format, is received into the interactive profile system, typically submitted by the user or client. The building can be any structure, such as a home, office or warehouse, and can also include the property that the structure occupies. The plan set is converted to a profile data set by the profiling engine. The profiling engine parses, or extracts, the profile data set to develop and link a plurality of potentially interrelated building. The profiling engine performs a systematic enhancement of the plan set, building upon the elemental physical descriptions of the plan set. Each element of the physical description is functionally analyzed for relational attributes and then expanded and tagged. The user directs a profile query to the application engine of the interactive profile system. The profile query is relatable to the enhanced profile and more specifically relatable to at least one of the plurality of interrelated elements of the building. Typical profile requests can include proposed or actual changes to the building, requests for material listings, and project assessments. Text-based Internet browsers such as Linux could also be employed. WAP (wireless application protocol) could also be utilized to access the interactive protocol system. WAP is a secure specification that allows users to access information instantly via handheld wireless devices such as mobile phones, pagers, two-way radios, “smart phones” and communicators.

U.S. Pat. No. 6,038,547, issued Mar. 14, 2000 to Casto, puts forth a construction tracking and payment method and computer system. After a project has been partitioned by an architect, jobs are specified in terms of to which region or subregion each entry corresponds. The (sub)contractors submit monthly Application and Certificate for Payment requests which are organized by the system to enable all the work in a particular region to be consolidated listed on a reviewer's card for ease of verification. Updates to the requests are made and authorized forms are generated to enable payment of the requests, thereby saving time and effort to perform manual correlation of subcontractor requests with a given area in a project. The invention provides a handheld computer having GPS capability which can be carried by a reviewer to provide consolidated reports in a region-by-region break down of the construction site.

Two U.S. Pat. No. 6,324,508 issued Nov. 27, 2001 and U.S. Pat. No. 6,658,387 issued Dec. 2, 2003 to Finney, concern an automated method for performing a construction quantity takeoff estimate of a drawing representative of a construction project having a plurality of items includes applying first vocal indicia representative of a selected item of the plurality of items to a voice recognition system and producing and first electrical signals representative of the first vocal indicia by the voice recognition system. The selected item is first determined by the voice recognition system in accordance with the first electrical signals. Second vocal indicia representative of a quantity of the selected item are applied to the voice recognition system and second electrical signals representative of the quantity of the selected item are produced. The quantity of the selected item is second determined by the voice recognition system in accordance with the second electrical signals. The takeoff estimate is performed in accordance with the first and second determining. In an alternate embodiment, Global Positioning System (GPS) input is used.

What is needed is a convenient dedicated device for construction estimating including GPS locating of client and cost estimates in a portable hand held device.

### BRIEF SUMMARY OF THE INVENTION

An object of the present invention is a convenient dedicated device for construction estimating including GPS locating of client and cost estimates in a portable hand held device the size of a clipboard with touch screen controls, internet connectivity, display and ordering capability.

In brief, the present invention comprises an Electronic Estimator which is like an electronic touch screen clipboard (size 10″×10″). The contractor can draw on it, use it as a touch screen to select materials for a job, can estimate costs including a running total of costs for a job, can input all client info. After initial contact by a potential customer, the contractor can input the client information including location and use a global positioning system (GPS) to travel to the client location. The contractor can use it to order materials for the job from the supplier.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a front perspective view of the electronic construction estimator of the present invention showing a front side with a touch screen;

FIG. 2 is a back perspective view of the electronic construction estimator of FIG. 1 showing a back side with a battery compartment and dock slot.

### DETAILED DESCRIPTION OF THE INVENTION

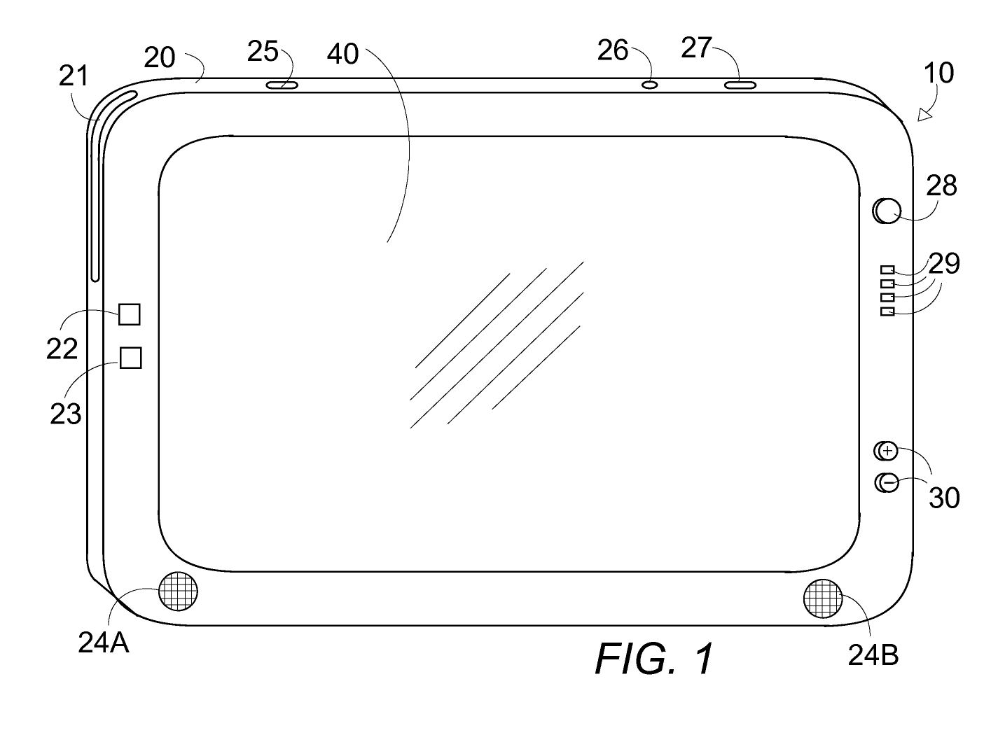

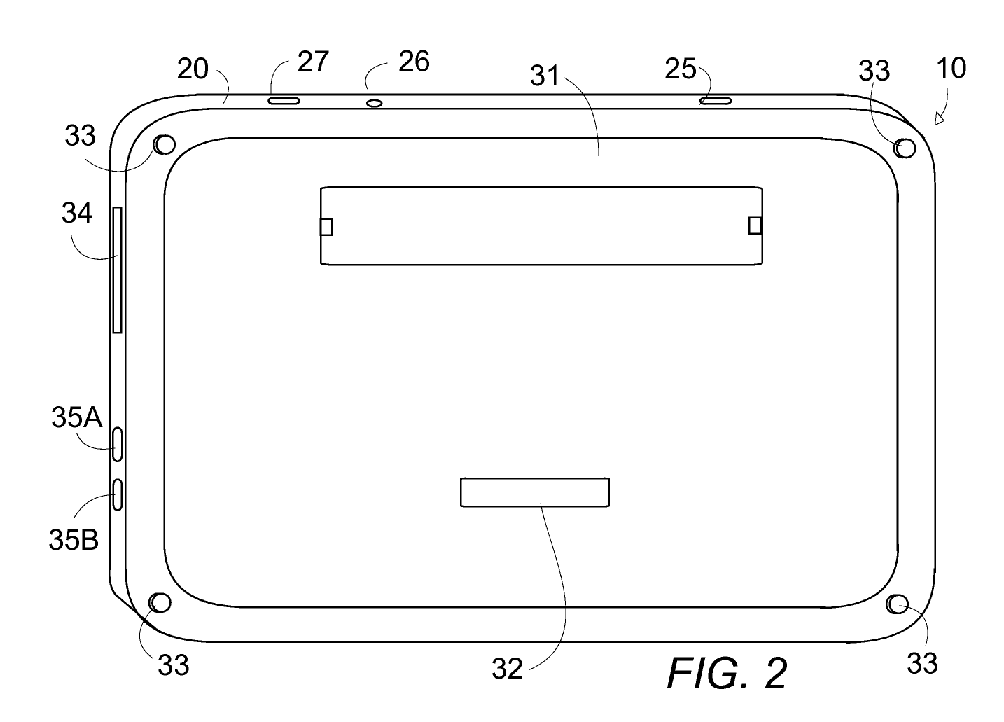

In FIGS. 1-2, an electronic construction estimator device comprises a dedicated mobile programmed electronic device 10 comprising a lightweight casing 20 for transporting and use by a contractor. The casing 20 housing programmable circuitry including means for digital storage both dedicated to estimating construction jobs, means for connecting to the Internet, and means for Global Positioning Satellite communication.

In FIG. 1, a touch screen 40 built into a front side of the casing 20 enables the contractor to input client information, to display information regarding services offered by the contractor, to input construction job related specifications, to display cost and material estimates, to order material, and to display a map and directions to a job location output by the means for Global Positioning Satellite communication.

At least one speaker, and preferably two speakers 24A and 24B are mounted in the casing for outputting sound for display information shown on the screen about contractor services, travel directions from the GPS system, and other information.

A device activation control 28 or power button on the casing turns the device on and off. A DC power plug receptacle 26 on the casing enables the device to be plugged into a DC power source in a vehicle or through a transformer into a regular wall outlet.

A credit card reader and related credit card sliding slot 21 on the casing 20 allows for credit card payment by a customer at the job site.

An infrared window 25 on the casing allows for wireless communication with other devices, such as a printer. A printer jack 27, such as a USB port enables a wired connection to other devices, such as a desktop computer or printer. Other USB ports 35A and 35B on the casing are also available to plug in other devices, as shown in FIG. 2.

In FIG. 2, a battery storage compartment 31 is built into the back of the casing for housing and accessing batteries inside the casing 20. A docking port 32 on the casing is used for a charger to charge the batteries. Battery power level lights 29 on the casing, as shown in FIG. 1, indicate the available power in the battery or batteries. Rubber pads 33 may be affixed to the corners of the back of the device for cushioning the device when placed on a flat surface.

A memory card port 34 in the casing for inserting a memory card to transmit digital information between the memory card and the means for digital storage inside the casing.

Control buttons 22 and 23 on the casing may be used for Internet connection and bookmark access.

In use, the electronic construction estimator device of the present invention is like an electronic touch screen clipboard (preferably up to a size 10″×10″). The contractor can draw on it, use it as a touch screen to select materials for a job, can estimate costs including a running total of costs for a job, can input all client info. After initial contact by a potential customer, the contractor can input the client information including location and use a global positioning satellite (GPS) technology to travel to the client location. The contractor can use it to order materials for the job from the supplier.

The present invention is useful both in the field and in the office for all construction trades. This device would help either a large or small office and an individual contractor.

The portable hand-held electronic device of the present invention will enable contractors to walk through a project with a customer and create an accurate estimate and material list.

Estimates and invoices are easily printable with a portable printer which may be part of the system used with the device or a desktop printer can be used with either an Infrared wireless connection or wired connection. Information can be sent via e-mail to the office to record it in a desktop computer.

The device of the present invention is fast and easy with touch screen click by click method, adding any material in any area.
For example:
Electrical: Switch color and shape, can light size, color and shape, ceiling fans etc. . . .
Plumber: Heater size and description for capacity, and any material s with price range.
Home Theater: Speakers size and color.
Roofer: Material and color selection.
Landscaper: Hardscape, softscape design.
Cabinet: material, color, design selection.

First contact of the contractor with the customer may be made by phone, email, internet input or other means. The customer information can be input into device by electronic pen including: phone, address, estimate date and all necessary information.

The device of the present invention will automatically locate the address of the customer and job site using GPS technology and save the address in memory.

Upon arrival at the costumer location, the contractor can show the customer recent projects and materials with photo and movie displays on the device of the present invention.

The device of the present invention can be used for a walk through a project site with the customer. On screen, the contractor can select any area, for example: living room, hallway, family room, office building, etc. project area selected and click in material list and select quantity, and add any material by a single click.

When all the material has been selected, the device software will add all material cost, labor and tax to total estimate amount for the project.

A separate screen can show all the material with picture selection and estimate time for labor.

The contractor can communicate with the office through the device to add or re-schedule a job, update phone number, address, email address or other information. Contractor can also add new customers and schedule a new estimate or scheduled job date and time, change material for an upcoming job and many other functions.

The customer can pay immediately with a credit card through the device using the wireless card reader built into the device.

It is understood that the preceding description is given merely by way of illustration and not in limitation of the invention and that various modifications may be made thereto without departing from the spirit of the invention as claimed.

1. A comprehensive contractor mobile device for a customer information base and locater, an electronic construction estimator, a construction material ordering system, a touch screen and electronic pen for inputting drawings and written information, and a promotional media display comprising, in combination:
a dedicated mobile programmed electronic device comprising a lightweight casing for transporting and use by a contractor, the casing housing programmable circuitry; software for job estimation and material purchasing, means for digital storage dedicated to estimating construction jobs; means for Internet communication for ordering construction job materials and communicating with customers, suppliers, and workers; a wireless telephone connection for communicating with customers, suppliers and workers; and means for Global Positioning Satellite communication;
a touch screen on a front side of the casing for the contractor to input client information, to display information regarding services offered by the contractor, to input construction job related specifications, to display cost and material estimates, to order construction job material, and to display a map and directions to a job location output by the means for Global Positioning Satellite communication, an electronic pen associated with the touch screen for inputting drawings and written information on the touch screen, and software for displaying photographs, movies and flash movies to a client on the touch screen;
at least one speaker in the casing for outputting sound;
a battery storage compartment in the back of the casing for accessing batteries inside the casing;
a docking port on the casing for a charger to charge the batteries;
an electric plug receptacle in the casing for DC current;
an infrared window on the casing for wireless communication with other electronic devices;
at least one port on the casing for receiving a plug for wired connections to other electronic devices for transferring information and communicating;
a device activation control on the casing;
a memory card port in the casing for inserting a memory card to transmit digital information between the memory card and the means for digital storage inside the casing;
a credit card reader and related credit card sliding slot on the casing for payment by customers;
together forming a comprehensive contractor mobile device for a customer information base and locator, an electronic construction estimator, a construction material ordering system, a touch screen and electronic pen for inputting drawings and written information, and a promotional media display.

2. The device of claim 1 further comprising a printing device port in the casing for connecting a portable printer to the device for printing information output by the device.

3. The device of claim 1 further comprising a printing device port in the casing for connecting a client printer to the device for printing information output by the device for the client.
